(19) United States
(12) Patent Application Publication
(10) Pub. No.: US 2008/0182094 A1
(43) Pub. Date: Jul. 31, 2008

(54) MULTILAYER COMPOSITE MATERIAL HAVING A LAYER OF POLYCARBONATE

(75) Inventors: Alexander Meyer, Dusseldorf (DE); Heinz Pudleiner, Krefeld (DE); Klaus Meyer, Dormagen (DE); Mehmet-Cengiz Yesildag, Leverkusen (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/020,926

(22) Filed: Jan. 28, 2008

(30) Foreign Application Priority Data
Jan. 29, 2007 (DE) 102007004332.7

(51) Int. Cl. B32B 27/00; B32B 37/00

(52) U.S. Cl. 428/220; 428/412; 156/60

(57) ABSTRACT

A multilayer composite material having at least one layer of (co)polycarbonate is disclosed. The (co)polycarbonate contains as end groups phenolate groups of formula (1)

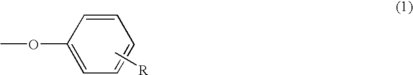

wherein R is selected from the group consisting of C₁₀-C₂₅-alkyl, C₁₀-C₂₅-alkoxy and C₁₀-C₂₅-alkyl-substituted aryl. The inventive composite material which may be transparent or colored, exhibits improved laminability and processability as compared with the prior art and may be laser-printable.

### FIELD OF THE INVENTION

The invention concerns a multilayered composite and more particularly a composite containing at least one (co)polycarbonate layer.

### TECHNICAL BACKGROUND THE INVENTION

Extruded films of polycarbonate, polyester carbonate or blends of PC and polyesters such as polyethylene terephthalates, polybutylene terephthalates or polycyclo-hexanedimethanol-cyclohexanedicarboxylate (PCCD) are used primarily in the electronics field, for decorative and functional covers in the domestic appliance sector, as cover films, for example for sports articles, for ID cards and blister packs. Further fields of application are in the motor vehicle construction sector, such as, for example, bodywork parts or exterior mirrors, or in the telecommunications field, such as, for example, mobile phone casings and mobile phone keypads. The films are distinguished by high transparency, impact resistance and dimensional stability under heat.

A particular field in which substrate materials are used in the production of films are portable data carriers. Portable data carriers are used iii a very wide variety of forms for a large number of applications. The portable data carriers frequently have an inscription, built-in security features, a magnetic stripe and/or an integrated circuit. In particular, the portable data carriers can be in the form of plastics cards of standard dimensions and can be used, for example, for carrying out transactions in the case of cashless payments or for demonstrating a fight of access to a mobile phone network, etc. Also known are portable data carriers which are generally thinner and of larger size than the standard plastics cards and which are integrated as a page into a passbook.

In view of the widespread use of portable data carriers, the environmental impact of the materials used is playing an increasingly greater role, in addition to the production costs. In most cases, it is still necessary to ensure that the portable data carriers have a long useful life, hi addition, portable data carriers are increasingly being provided with inscriptions and additional elements, the associated demands in terms of quality increasing at the same time.

A known method for producing high-quality portable data carriers is the lamination of a plurality of plastics films. However, the production of portable data carriers of complex construction from a large number of individual films is expensive and subject to considerable limitations in respect of the choice of materials in particular for adjacent individual films. In addition, the individual films must have a particular minimum thickness in order that they may be handled. For this reason, coextruded films consisting of a plurality of layers have already started to be used for the production of portable data carriers. The individual layers are joined together during their production to form a multilayer film. A plurality of these multilayer films may then be joined together by lamination.

Such a procedure is known from EP-A-0 640 940, for example, which discloses a contactless chip card having a core film arranged between two cover films. The cover films are each joined to the core film by means of a joining layer. The joining layer in each case is in particular in the form of a layer coextruded with the cover films and/or with the core film. The cover films and the core film consist of polycarbonate, for example. The joining layers car consist of a modified polyester known as PETG.

From U.S. Pat. No. 5,928,788 there is known, inter alia, a multilayer data carrier which is produced by lamination of a core film aid two cover films. The core film and the cover films consist in particular of PETS. In order to prevent excessively strong adhesion to the plates of the laminating press, the cover films are enriched with antiblocking substances in the outer region. To this end, the cover films are each coextruded from two layers, only one of these layers containing the antiblocking substances.

WO 02/41245 discloses a multifunctional card body formed from a plurality of films joined together by lamination, at least one film consisting of at least two coextruded layers. In particular, a core film is joined on both sides to a cover film. The cover films can each be in the form of a coextruded polycarbonate film having two or three coextruded layers. The core film can contain two different types of coextruded layer. The two types of coextruded layer follow one another alternately, a layer structure of three or five alternating coextruded layers being formed. One type of coextruded layer can consist of polycarbonate or polyethylene terephthalate (PET). The other type of coextruded layer can consist of a thermoplastic elastomer.

EP-A-0 706 152 discloses laminated chip cards or smart cards composed of thermoplastic materials. This composite produced by lamination of films exhibits marked advantages over cards produced by a complex adhesive-bonding process, for example by means of cyanoacrylate adhesives.

Polycarbonate is particularly suitable for the above-described films owing to its good mechanical properties.

Polycarbonates having alkylphenol end groups are disclosed in U.S. Pat. No. 6,288,205, for example. Such polycarbonates are disclosed in that patent as substrate materials for optical data carriers, because they exhibit better processing properties in the injection-molding process. Card applications or lamination properties are not described.

DE 19933128 disclosed polycarbonates which have long-chain alkylphenol end groups and at the same time exhibit fewer defeats amid are free of solvents. Card applications or lamination properties are not described.

In US 200310212241, polycarbonates having long-chain alkylphenols as end groups are disclosed for optical data carriers. These substrates exhibit better pit formation and are therefore particularly suitable for optical storage media. Card applications or lamination properties are not described.

JP 200341011 disclosed polycarbonates for optical data storage means. Some of the polycarbonates are modified with long-chain alkylphenols. These substrate materials are distinguished by better dimensional stability as compared with other substrate materials and are therefore particularly suitable for optical disks, Card applications or lamination properties are not described.

US 200310144456 disclosed polycarbonates obtained by the melt transesterification process. In that process, long-chain alkyl phenols are in some cases used. Card applications or lamination properties are not described.

WO 02/38647 disclosed polycarbonates having long-chain alkylphenols for injection-molding applications. Card applications of lamination properties are not described.

The production of the finished card body or multilayer composite material is carried out in particular by means of a laminating press, in which the bundle of films is intimately bonded under the action of pressure. It is advantageous thereby if at least one of the core films or cover films has a very good tendency to adhere during the laminating process. The process of producing the film composites may be accelerated as a result. The adhesion of the cover films to the core film is also improved. The core film may be transparent and/or colored and may have good mechanical properties. Furthermore, the cover films may be laser-printable. For this reason, polycarbonate is preferred. Films of polycarbonate have the disadvantage of a high processing temperature in the laminating process. Furthermore, a relatively long time is required to laminate the films. As a result, the above-described lamination cycles are lengthened and long production times are necessary. Delamination may also occur during the use phase of the finished film laminate owing to inadequate adhesion between the films.

The object was, therefore, to provide a film which satisfies the demands of good mechanical properties, such as, for example, impact resistance, and exhibits improved laminability and processability as compared with the prior art, and which at the same fire is transparent, may be colored and is laser-printable.

### SUMMARY OF THE INVENTION

A multilayer composite material having at least one layer of (co)polycarbonate is disclosed. The (co)polycarbonate contains as end groups phenolate groups of formula (1)

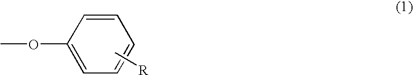

wherein R is selected from the group consisting of C₁₀-C₂₅-alkyl, C₁₀-C₂₅-alkoxy and C₁₀-C₂₅-alkyl-substituted aryl. The inventive composite material which may be transparent or colored, exhibits improved laminability and processability as compared with the prior at and may be laser-printable.

### DETAILED DESCRIPTION OF THE INVENTION

Surprisingly, it has been found that such a multilayer composite material has the properties required above.

The expression “multilayer composite material” denotes a material having 2, 3, 4, 5 or more layers which are joined together, for example by coextrusion or lamination. The layers may comprise different materials. Even when two layers predominantly comprise the same material, they are nevertheless considered as different layers within the scope of the present invention if these two layers are produced and brought in contact to each in separate working steps. They are also considered as different layers if they contain different additives.

The expression “at least one layer” means that the multilayer composite material includes one or more such layers.

The expression “contain phenolate groups of formula (I)” means that the molecular structure of the (co)polycarbonate includes units conforming to formula (I). The molar content of such units is greater than zero.

The expression “consist substantially of phenolate groups of formula (I)” means that the portion of polycarbonate consisting of such phenolate groups is such that the advantages according to the invention are retained.

The expression “C₁₀-C₂₅-alkyl” denotes a linear or branched hydrocarbon radical having 10 to 25 carbon atoms, in particular linear C₁₂-C₂₀-alkyl, most particularly pentadecyl. The expression “C₁₀-C₂₅-alkyl-substituted aryl” denotes a phenyl or naphthyl radical substituted by C₁₀-C₂₅-alkyl.

In the suitable (co)polycarbonates, up to 40% of the end groups may include conventionally used phenolic groups, such as phenol, tert.-butylphenol, cumylphenol, octylphenol or other mono- and/or di-substituted phenolic groups. The suitable (co)polycarbonate for preparing the film according to the invention preferably contains more than 80%, in particular more than 90%, end groups of formula 1, the percent relative to total molar amount of end groups

The content of end groups, for example the pentadecylphenol content, may be determined, for example, by NR spectroscopy via integration of the aliphatic protons. A more accurate analysis entails the total alkaline saponification of the polycarbonate and a subsequent HPLC analysis, an appropriate calibration with the pure substance pentadecylphenol being carried oat beforehand.

By way of a non-limiting example, the polycarbonate for the film according to the invention may be described by formula 2:

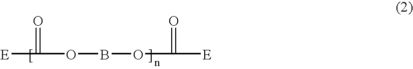

wherein
—O—B—O— corresponds to the residue of a bisphenolate radical, n is an integer of at least 1, and the radicals E correspond to the phenolate radicals represented by formula 1, the latter being bridged via the oxygen. It is also possible to use any desired mixture of bisphenolates, that is to say that the inventive polycarbonates embraces copolycarbonates as well.

Examples of diphenols suitable for the preparation of the polycarbonates that are to be us are hydroquinone, resorcinol, dihydroxydiphenyl, bis-(hydroxyphenyl)-alkanes, bis-(hydroxyphenyl)-cycloalkanes, bis-(hydroxyphenyl) sulfides, bis-(hydroxyphenyl) ethers, bis-(hydroxyphenyl) ketones, bis-(hydroxyphenyl)-sulfones, bis-(hydroxyphenyl) sulfoxides, α,α′-bis-(hydroxyphenyl)-disopropylbenzenes, as well as the compounds thereof that are alkylated, alkylated on the ring and halogenated on the ring.

Preferred diphenols are 4,4′-dihydroxydiphenyl, 2,2-bis-(4-hydroxyphenyl)-1-phenyl-propane, 1,1-bis-(4-hydroxyphenyl)-phenyl-ethane, 2,2-bis-(4-hydroxy-phenyl)propane, 2,4-bis-(4-hydroxyphenyl)-2-methylbutane, 1,3-bis-[2-(4-hydroxyphenyl)-2-propyl]benzene (bisphenol M), 2,2-bis-(3-methyl-4-hydroxyphenyl)-propane, bis-(3,5-dimethyl-4-hydroxyphenyl)-methane, 2,2-bis-(3,5-dimethyl-4-hydroxyphenyl)-propane, bis-(3,5-dimethyl-4-hydroxyphenyl)-sulfone, 2,4-bis-(3,5-dimethyl-4-hydroxyphenyl)-2-methylbutane, 1,3-bis-[2-(3,5-dimethyl-4-hydroxyphenyl)-2-propyl]benzene and 1,1-bis-(4-hydroxyphenyl)-3,3,5-trimethylcyclohexane (bisphenol TMC).

Particularly preferred diphenols are 4,4′-dihydroxydiphenyl, 1-bis-(4-hydroxy-phenyl)-phenyl-ethane, 2,2-bis-(4-hydroxyphenyl)-propane, 2,2-bis-(3,5-dimethyl-4-hydroxyphenyl)-propane, 1,1-bis-(4-hydroxyphenyl)-cyclohexane and 1,1-is-(4-hydroxyphenyl)-3,3,5-trimethylcyclohexane (bisphenol TMC).

These and further suitable diphenols are described, for example, in U.S. Pat. Nos. 2,999,835, 3,148,172, 2,991,273, 3,271,367, 4,982,014 and 2,999,846, in German Offenlegungsschrift 1 570 703, 2 063 050, 2 036 052, 2 211 956 and 3 832 396, in French patent specification 1 561 518, in the monograph “H. Schnell, Chemistry and Physics of Polycarbonates, Interscience Publishers, New York 1964, p. 28ff, p. 102ff” and in “D. G. Legrand, J. T. Bendler, Handbook of Polycarbonate Science and Technology, Marcel Dekker New York 2000, p. 72ff” all incorporated herein by reference.

In the case of the homopolycarbonates, only one diphenol is used; in the case of the copolycarbonates, a plurality of diphenols is used, it being possible, of course, for the bisphenols used, like all the other chemicals and auxiliary substances added to the synthesis, to be contaminated with impurities from their own synthesis, handling and storage, although it is desirable to work with raw materials that are as pure as possible.

The chain terminators to be used, which after synthesis are represented by formula 1, are, for example, long-chain alkylphenols such as decyl-, undecyl-, dodecyl-, tridecyl-, pentadecyl-, hexadecyl-, heptadecyl-, octadecyl-phenol. The phenols may carry the substituents in the o-, m- or p-position. Of course, these substances may be contaminated with impurities from their own synthesis, handling and storage. For example, these phenols may be contaminated by further phenols, disubstituted phenols, long-chain fatty acids, dihydroxybenzenes and alkyldihydroxybenzenes. Such substances are for the most pad likewise incorporated into the polycarbonate.

In order to adjust the molecular weight, up to 40 mol. % of further monofunctional phenols, such as phenol, p-tert.-butylphenol, isooctylphenol, cumylphenol, chlorocarbonic acid esters thereof or acid chlorides of monocarboxylic acids, or mixtures thereof, may be used.

The total amount of phenolic chain terminators in the (co)polycarbonate suitable in the context of the invention is 0.1 to 10 mol %, based on the moles of diphenols.

Also suitable in the context of the invention are branched polycarbonate, obtained by adding during the synthesis at least one branching agent iii the form of a trifunctional or tetra-functional compound. Trisphenols, quaternary phenols or acid chlorides of tri- or tetra-carboxylic acids, or mixtures of the polyphenols or of the acid chlorides, are conventionally used.

Some of the compounds having three or more than three phenolic hydroxyl groups that may be used are, for example:
phloroglucinol,
4,6-dimethyl-2,4,6-tri-(4-hydroxyphenyl)-hept-2-ene,
4,6-dimethyl-2,4,6-tri-(4-hydroxyphenyl)-heptane,
1,3,5-tri-(4-hydroxyphenyl)-benzene,
1,1,1-tri-(4-hydroxyphenyl)-ethane,
tri-(4-hydroxyphenyl)-phenylmethane,
2,2-bis[4,4-bis-(4-hydroxyphenyl)-cyclohexyl]-propane,
2,4-bis-(4-hydroxyphenyl-isopropyl)-phenol,
tetra-(4-hydroxyphenyl)-methane.

Some of the other trifunctional compounds are 2,4-dihydroxybenzoic acid, trimesic acid, cyanuric chloride and 3,3-bis(3-methyl-4-hydroxyphenyl)-2-oxo-2,3-dihydroindole.

Preferred branching agents are 3,3-bis-(3-methyl-4-hydroxyphenyl)-2-oxo-2,3-dihydroindole and 1,1,1-tri-(4-hydroxyphenyl)-ethane.
Preferred polycarbonates, in addition to the homopolycarbonates of bisphenol A, are the copolycarbonates of bisphenol A having up to 15 mol. %, based on the total number of moles of diphenols, of diphenols other than those, mentioned as being preferred or particularly preferred, in particular of 2,2-bis-(3,5-dibromo-4-hydroxyphenyl)-propane, 1,3-dihydroxybenzene.

Various additives may be added to the suitable polycarbonates.

The addition of additives serves to extend the useful life or the color (stabilizers), to simply processing (e.g. mold release agents, flow aids, antistatics) or to adapt the polymer properties to particular stresses (impact modifiers, such as rubbers; flameproofing agents, colorings, glass fibers).

These additives may be added to the polymer melt individually or in the form of any desired mixtures or a plurality of different mixtures, either directly during isolation of the polymer or after melting of granules in a so-called compounding step. The additives, or mixtures thereof, may be added to the polymer melt in the form of a solid, that is to say in powder form, or in the form of a melt. Another type of addition is the use of masterbatches or mixtures of masterbatches of the additives or additive mixtures.

Suitable additives are described, for example, in “Additives for Plastics Handbook, John Murphy, Elsevier, Oxford 1999”, in “Plastics Additives Handbook, Hans Zweifel, Hanser, Munich 2001” incorporated herein by reference.

Suitable antioxidants or heat stabilizers are, for example:

alkylated monophenols,
alkylthiomethylphenols,
hydroquinones and alkylated hydroquinones,
tocopherols,
hydroxylated thiodiphenyl others,
alkylidenebisphenols,
O-, N- and S-benzyl compounds,
hydroxybenzylated malonates,
aromatic hydroxybenzyl compounds,
triazine compounds,
acylaminophenols,
esters of β-(3,5-di-tert.-butyl-4-hydroxyphenyl)propionic acid,
esters of β-(5-tert-butyl-4-hydroxy-3-methylphenyl)propionic acid,
esters of β-(3,5-dicyclohexyl-4-hydroxyphenyl)propionic acid,
esters of 3,5-di-tert.-butyl-4-hydroxyphenylacetic acid,
amides of β-(3,5-di-tert.-butyl-4-hydroxyphenyl)propionic acid,
suitable thiosynergists,
secondary antioxidants, phosphites mid phosphonites, benzofuranones and indolinones.

Preference is given to organic phosphites, phosphonates and phosphanes, in most cases those in which the organic radicals include wholly or partially optionally substituted aromatic radicals.

Suitable complexing agents for heavy metals and for the neutralization of alkali traces are o/m-phosphoric acids, wholly or partially esterified phosphates or phosphites.

Suitable light stabilizers (UV absorbers) are:

2-(2′-hydroxyphenyl)benzotriazoles,
2-hydroxybenzophenones,
esters of substituted and unsubstituted benzoic acids,
acrylates,
sterically hindered amines,
oxamides,
2.8.2-(2-hydroxyphenyl)-1,3,5-triazines,
with preference being given to substituted benzotriazoles.

Polypropylene glycols, on their own or in combination with, for example, sulfones or sulfonamides as stabilizers, may be used against damage by gamma rays.

These and other stabilizers may be used individually or in combinations and may be added in the mentioned forms to the polymer.

In addition, processing aids such as mold release agents, mostly derivatives of long-chain fatty acids, may be added, Preference is given to pentaerythritol tetrastearate and glycerol monostearate, for example. They are used on their own or in a mixture, preferably in an amount of from 0.02 to 1 wt. %, based on the weight of the composition.

Suitable flame-retarding additives are phosphate esters) that is to say triphenyl phosphate, resorcinoldiphosphoric acid ester, bromine-containing compounds, such as brominated phosphoric acid esters, brominated oligocarbonates and polycarbonates, amid also, preferably, salts of fluorinated organic sulfonic acids.

Suitable impact modifiers include butadiene rubber with grafted-on styrene-acrylonitrile or methyl methacrylate, ethylene-propylene rubbers with grafted-on maleic anhydride, ethyl acrylate and butyl acrylate rubbers with grafted-on methyl methacrylate or styrene-acrylonitrile, interpenetrating siloxane and acrylate networks with grafted-on methyl methacrylate or styrene-acrylonitrile.

It is further possible to add coloring agents, such as organic dyes or pigments or inorganic pigments, IR absorbers, individually, in a mixture or in combination with stabilizers, glass fibers, (hollow) glass beads, inorganic fillers.

Different layer-specific functions of the films themselves may be achieved by different types of additives.

As the outer cover layer, the polycarbonate layer according to the invention may contain a laser-sensitive additive. A suitable additive is carbon black or an infrared-light-absorbing dye.

When standard lasers are used, especially the widely used Nd-VAG solid-state laser having a wavelength of 1.06 μm, a color change or color shift takes place at the point of impact of the laser on the surface of the material, amid sharp, high-contrast inscriptions and markings are obtained.

Suitable additives are in particular colored pigments and metal salts, copper hydroxide phosphate, iriodine, a pearlescent pigment, as is commercially available from Merck; above all, however, carbon black. These additives are added to the polycarbonate according to the invention in particular in the order of magnitude of from a few per thousand to a maximum of 10 percent.

The polycarbonate layer according to the invention may also contain further inorganic fillers, for example titanium dioxide, barium sulfate, etc.

The amount of such inorganic fillers in the polycarbonate is preferably from 2 to 50 wt. %, particularly preferably front 3 to 30 wt. %.

Examples of suitable inorganic fillers for achieving an opaque or translucent polycarbonate layer are conventional inorganic pigments, in particular metals or metal oxides such as aluminium oxides, silica, titanates, as well as alkali metal salts such as carbonates or sulfates of calcium or barium. Suitable particulate fillers may be homogeneous and include predominantly one material, such as titanium dioxide or barium sulfate. Alternatively, at least one component of the filler may be heterogeneous. Accordingly, a modifier may be added to the actual filler. For example, the actual filler may be provided with a surface modifier, such as, for example, a pigment, a processing aid, a surfactant or another modifying agent, in order to improve or change its compatibility with the polycarbonate. In a particular embodiment, the polycarbonate layer contains titanium dioxide.

The preparation of the polycarbonates that are to be used for the films or coextruded films takes place inter aha by the interfacial process. This process for polycarbonate synthesis has been widely described in the literature; reference may be made, for example, to R. Schnell, Chemistry and Physics of Polycarbonates, Polymer Reviews, Vol. 9, Interscience Publishers, New York 1964 p, 33 ff, to Polymer Reviews, Vol. 10, “Condensation Polymers by Interfacial and Solution Methods”, Paul W. Morgan, Interscience Publishers, New York 1965, Chap, VII, p, 325, to Dres. U. Grigo, K. Kircher and P. R. Müller “Polycarbonate” in Becker/Braun, Kunststoff-Handbuch, Volume 3/1, Polycarbonate, Polyacetale, Polyester, Celluloseester, Carl Hanser Verlag Munich, Vienna 1992, p. 118-145, and to EP-A 0 517 044.

According to this process, the phosgenation of a disodium sail of a bisphenol (or of a mixture of various bisphenols) which has been placed in an aqueous-alkaline solution (or suspension) takes place in the presence of an inert organic solvent or solvent mixture, which forms a second phase. The resulting oligocarbonates, which are present predominantly in the organic phase, are condensed with the aid of suitable catalysts to give high molecular weight polycarbonates dissolved in the organic phase. The organic phase is finally separated off and the polycarbonate is isolated therefrom by various working-up steps.

The continuous polycarbonate preparation process according to the interfacial process is especially suitable for the preparation of the polycarbonate that is to be used. Particular preference is given to a continuous process, which uses a recirculating reactor as the phosgenation reactor and downstream tubular reactors.

The improved lamination properties may also be achieved by other methods. For example, a different polymer, such as PMMA, may be used. However, the mechanical properties are markedly poorer in this case. Polymer blends, for example based on polycarbonate also be prepared. However, such blends mostly have markedly poorer optical and mechanical properties. Additives may also improve the lamination properties, but the processability is markedly poorer because additives have a tendency to form coatings on the surface of the films or on the laminating rollers. Additives may additionally evaporate and lead to foul odors or health problems.

The above-indicated film according to the invention is therefore particularly suitable for the production of the film composites. These films may be transparent, laser-printable and colored.

The thickness of the films is preferably from 5 to 1000 μm, particularly preferably from 5 to 850 μm.

In order to produce the films, the components are mixed and conventionally compounded by means of an extruder at temperatures of approximately from 260° C. to 320° C.

The films may be smooth on one side or on both sides, or they may be matt or structured on one side or on both sides.

For the production of films by extrusion, the polycarbonate granules are fed to the filling hopper of an extruder and pass via the hopper into the plastification system, which include a screw and a cylinder.

In the plastification system, the material is conveyed and melted. The melt is pressed through a flat sheet die. A filter device, a pump, stationary mixing elements and further components may be interposed between the plastification system and the flat sheet die. The melt leaving the die optionally passes onto a polished calendar roll. Final shaping takes place in the gap between the calendar rolls. Finally, thickness and surface texture are fixed by cooling this may take place, for example, by cooling on the calender rolls or in ambient air. Further equipment serves for transportation, to apply protective film, and to wind up the extruded films.

In the case of coextrusion (herein “coex”), the material to be coextruded is plastified in the same manner in one or more further extruders. The coex melt(s) is (are) brought together with the main material in a special coex adapter upstream of the die or in a special coex die. The coex layer may be applied to one side or to both sides of the base layer. Subsequent working of the films may be carried out by thermoforming or hot forming or surface treatments, such as the provision of scratch-resistant coatings, water-repellent layers and other functional layers.

The films according to the invention are suitable in particular for the production of the cards described hereinbefore, such as, for example, smart ID cards, chip cards generally, EC cards, credit cards, insurance cards, passes, RFID tags, driving licenses, etc. Such data carriers consist of core and cover films assembled in different ways. Coextruded films are also used. The films or coextruded films according to the invention may be assembled in any desired manner with other films such as, for example, conventional polycarbonate films, films of polyesters, co-polyesters and/or crystalline, semi-crystalline or microcrystalline polyesters. Furthermore, films of PVC, ABS, PETG or PET or mixed forms thereof, such as PC/ABS, may additionally be used. The invention therefore also provides composite systems comprising such materials and the alkyl-modified polycarbonate. The arrangement of the films may be chosen differently according to the application. The individual films or coextruded films may have different thicknesses. The data carrier or the card may be constructed symmetrically or asymmetrically. The data carrier may be in the form of a page of a passbook, for example.

It is also possible for the data carrier to be in the form of a plastics card, in particular a magnetic stripe card or a chip card.

In order to retain the required properties of the data carrier, the film according to the invention may be metallised, structured or printed—for example with strip conductors. Structuring and printing may be carried out by the screen printing process.

The use of the films is not limited to the data carriers described above, but they may also be used in the case of chip half-cards, key heads, buttons, wrist bands, watch components, etc.

The invention is explained further by means of the following examples.

### EXAMPLES

### General Description

In order to study the laminating properties, polycarbonate was prepared. Films were produced from the polycarbonate and laminated with one another in a hot press. The stability of the film composite was determined either by hand or by means of a tensile machine. In using the tensile machine the force required to separate the films from one another was measured.

### Preparation of Polycarbonate Granules

40 litres of methylene chloride were added to a solution, rendered inert with nitrogen, of 4566 g (20 mol.) of bisphenol A and 3520 g (88 mol.) of sodium hydroxide in 40 litres of water. 3556 g (40 mol.) of phosgene were introduced at a pH of from 12.5 to 13.5 and at 20° C. 30% sodium hydroxide solution (about 7000 g) was added during the phosgenation in order to prevent the pH from falling below 12.5. When the phosgenation was complete, and after flushing with nitrogen, 258 g (0.85 mol.) of n-pentadecylphenol (technical grade from Sigma-Aldrich, USA) dissolved in 1 liter of dichloromethane were added. Stirring was carried out for 10 minutes, and 22.6 g (0.2 mol.) of N-ethylpiperidine were added, and stirring was continued for a further one hour. The aqueous phase was separated off, and then the organic phase was acidified with phosphoric acid and washed with distilled water until neutral and free of salt. After replacing the solvent with chlorobenzene, the product was extruded by means of an evaporation extruder at 290° C. and 80 revolutions/minute at 0.1 mbar and granulated by means of a granulator.

### Production of the Film

The polycarbonate described above was used for the extrusion of a polycarbonate film having a width of 350 mm.

The installation used included

an extruder from Stork having a screw of 37 mm diameter (D) and a length of 24×D. The screw had a degassing zone;

a flat sheet die having a width of 350 mm;

lip gap: 0.8 mm

a take-off device;

winding station.

The melt passed from the die onto a roll with a polished surface and then onto the cooling roll, the roll having the temperature specified in Table 1. The film was then transported through a take-off device and then wound up.

### Process Parameters:

Process parameter

| | |
|---|---|
| Temperature cylinder 1 | 230° C. |
| Temperature cylinder 2 | 235° C. |
| Temperature cylinder 3 | 240° C. |
| Temperature degassing | 240° C. |
| Temperature die 1 | 240° C. |
| Temperature die 2 | 240° C. |
| Temperature die 3 | 240° C. |
| Screw Speed | 30 r.p.m. |
| Temperature polished roll | 100° C. |
| Temperature cooling roll | 100° C. |
| Current consumption extruder | 16.5 A |
| Melt pressure | 80 bar |
| Film thickness | 150 μm |

### Lamination Example 1

The film so produced was laminated by means of a Weber press (Weber Presse, hydraulic type PW 30) at various temperatures and at a pressure of 60 kN and for a time of 10 minutes onto a conventional polycarbonate film having a melt volume rate (MVR) of about 6 cm³/10 minutes (300° C./1.2 kg), measured according to ISO 1133 (Makrolon® 3108) from Bayer MaterialScience AG, Germany. A spacer of aluminium film was introduced in an end portion of the films in order to manually test the lamination properties,

### Test of Lamination Behavior:

A test is cared out by hand to determine whether the films may be detached from one another without being damaged,

| Temperature | Result |
|---|---|
| 140° C. | strong film composite; cannot be separated without being |
| | damaged |
| 150° C. | strong film composite; cannot be separated without being |
| | damaged |

### Lamination Example 2

Testing and measurement of the lamination behavior were carried out as in Lamination Example 1, but two films according to the invention are laminated together.

| Temperature | Result |
|---|---|
| 140° C. | strong film composite; cannot be separated without being |
| | damaged |
| 150° C. | strong film composite; cannot be separated without being |
| | damaged |

### Lamination Example 3 (Comparison Example)

Testing and measurement of the lamination behavior were carried out as in Lamination Example 1, but two commercially available polycarbonate films (of Makrolon® 3108) from Bayer MaterialScience were laminated together.

| Temperature | Result |
|---|---|
| 150° C. | films barely adhered to one another, no lamination, |
| | films may easily be separated from one another |

### Lamination Example 4

The film according to the invention so produced was laminated by means of a type LA 63 hydraulic laboratory press from Bürkle, machine number 3633, at various temperatures, under the conditions indicated in the table, onto a conventional polycarbonate film (of Makrolon® 3108) from Bayer MaterialScience. A spacer of aluminium film was introduced in an end portion of the films in order subsequently to allow the laminate to be clamped into the clamps of the tensile testing machine.

The stability of the film composite was determined by means of a separation test in a tensile testing machine in accordance with DIN 53357. The force required to separate the films from one another was measured.

| | | | Film according to |
|---|---|---|---|
| | | Makrolon 3108 | the invention |
| | Makrolon 3108 film | against film | against film |
| | against Makrolon | according to | according to the |
| Temperature | 3108 film | the invention | invention |
| 120° C. | no adhesion | no adhesion | no adhesion |
| 130° C. | no adhesion | no adhesion | 0.04 N/mm |
| 140° C. | no adhesion | 0.31 N/mm | 1.06 N/mm, |
| | | | sample tore before |
| | | | separating |

The tests show the increased adhesion of the films according to the invention oil lamination.

Although the invention has been described in detail in the foregoing for the purpose of illustration, it is to be understood that such detail is solely for that purpose and that variations maybe made therein by those skilled in the art without departing from the spirit and scope of the invention except as it may be limited by the claims.

What is clamed is:

1. A multilayer composite material comprising at least one layer of (co)polycarbonate the molecular structure of which contains end groups at least one of which conforming to formula (1) 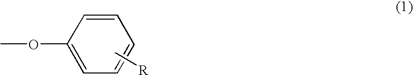
wherein R is a member selected from the group consisting of C₁₀-C₂₅-alkyl, C₁₀-C₂₅-alkoxy and C₁₀-C₂₅-alkyl-substituted aryl.

2. The composite material according to claim 1, wherein said R is linear C₁₂-C₂₀-alkyl.

3. The composite material according to claim 1 wherein said R is m-pentadecyl.

4. The composite material according to claim 1, wherein said end groups includes mostly phenolate groups of formula (I).

5. The composite material according to claim 4, wherein said phenolate groups of formula (I) amount to at least 80% relative to the molar amount of end groups.

6. The composite material according to claim 1, having a thickness of 0.1 to 2 mm.

7. The composite material according to claim 1, wherein said at least one layer is a coextruded film.

8. The composite material according to claim 1 in the form of a member selected from the group consisting of smart ID card, pass, portable data carrier, EC card, health card, credit card and mobile phone card.

9. A process for the production of the composite material according to claim 1 comprising laminating the at least one layer of (co)polycarbonate onto another film.
